(19) United States
(12) Patent Application Publication
(10) Pub. No.: US 2002/0130744 A1
(43) Pub. Date: Sep. 19, 2002

(54) Tripping device for a circuit breaker

(76) Inventors: Gerd Jodehl, Wasbeck (DE); Gabor Henrichs, Hamburg (DE); Christian-Alfons Thamm, Aukrug (DE); Stefan Kranz, Eutin (DE); Walter Felden, Neumunster (DE); Rolf-Dieter Bauer, Rastorf (DE)

Correspondence Address: PATENT OPERATION, GENERAL ELECTRIC COMPANY, 41 WOODFORD AVENUE, PLAINVILLE, CT, 06062

(21) Appl. No.: 09/681,321

(22) Filed: Mar. 16, 2001

(51) Int. Cl. H01H 9/00

(52) U.S. Cl. 335/172

(57) ABSTRACT

The invention provides a tripping device for a circuit breaker having contacts arranged in a housing, said contacts being separable by actuation of a tripping shaft of a shutoff device. An exhaust duct assigned to said contacts is constructed in said housing. A lever rotatably arranged on said housing is interactively connected to said tripping shaft, and has a barrier surface associated with said exhaust duct which as the result of a pressure surge in said exhaust duct deflects said lever to actuate said tripping shaft.

### FIELD OF THE INVENTION

The invention relates to a tripping device for a circuit breaker. More particularly, the invention relates to a tripping device utilizing a pressure activated mechanism to trip the circuit breaker mechanism.

### BACKGROUND OF THE INVENTION

A circuit breaker is known from European Patent 0583 1 49 B1 that is equipped with contacts for quick shutoff by electrodynamic repulsion in the event of a short circuit. When quick shutoff occurs, an electric arc drawn between said contacts is created that causes a rapid pressure rise in the housing containing said contacts. In the circuit breaker known from the cited patent, a pressure chamber is connected to said housing so that, when said electric arc is formed, the pressure likewise rises in said pressure chamber. Said pressure chamber is sealed from its surroundings by a movable piston that is displaced within said pressure chamber as a result of the pressure rise. Said piston is interactively connected to a shutoff switch so that said circuit breaker is switched off by the pressure rise.

However, the design of a pressure chamber with a sealing and movable piston entails high production costs. In addition, said pressure chamber and said piston require additional space, thereby increasing the overall dimensions of the circuit breaker. Furthermore, installation of said circuit breaker can easily create distortions in the housing, which can lead to jamming of said piston.

Consequently, there is a need for a tripping device for a circuit breaker that is economical to produce and that reliably enables said circuit breaker to be shut off in response to a pressure surge.

### SUMMARY OF INVENTION

The invention relates to a tripping device for a circuit breaker that has contacts arranged in a housing, said contacts being separable by actuation of a tripping unit of a shutoff device. An exhaust duct assigned to said contacts is constructed in said housing. A lever interactively connected to said tripping unit has a barrier surface associated with said exhaust duct that deflects said lever as the result of a pressure surge in said exhaust duct, causing said lever to actuate said tripping unit.

### BRIEF DESCRIPTION OF DRAWINGS

These and other features, aspects, and advantages of the present invention will become better understood with reference to the following description, appended claims and accompanying drawings in which:

FIG. 1 shows a schematic perspective partial view of a circuit breaker trip unit;

FIG. 2 shows a schematic side view of a section of the trip unit shown in FIG. 1;

FIG. 3 shows a schematic side view of a section of an alternate embodiment of a circuit breaker trip unit in the untripped position; and

FIG. 4 shows a side plan view of the circuit breaker trip unit shown in FIG. 3, in the tripped position.

### DETAILED DESCRIPTION

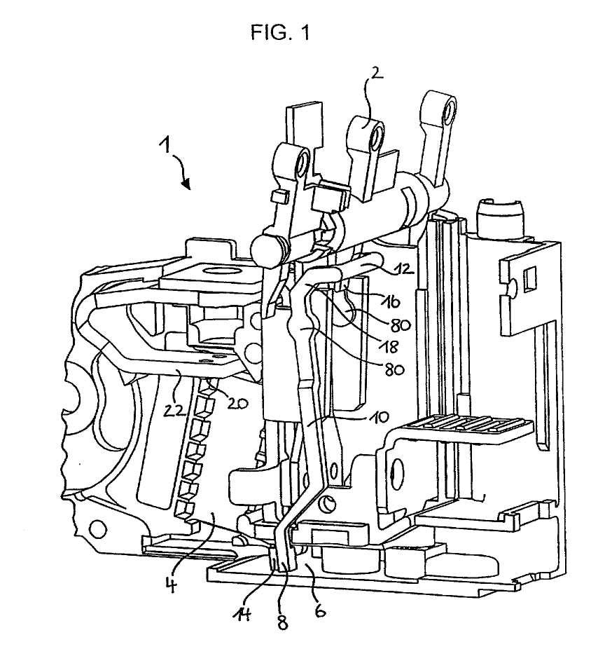

FIG. 1 shows a partial cutaway perspective view of a first embodiment example of the invention. FIG. 1 shows a housing that is assembled from two housing shells. The housing encloses a cavity that contains the electrical elements of the circuit breaker. The housing has various bearing points for supporting elements, as will be described hereinafter. In general, “supported on the housing”as referred to in the following description means that corresponding bearing journals, bearing openings, and the like are situated on the housing. The housing is composed of an insulating material, preferably of plastic. FIG. 1 also shows a contact carrier 22 in the housing, with a fixed contact 20 for the circuit breaker 1 attached thereto. A movable contact assigned to the fixed contact 20 is omitted here in order to provide only a broad overview. The circular centrodes of the movable contact, which is designed as a rotatable contact bridge, are arranged in the housing wall, as can be seen from FIG. 1. In addition, circular bearing openings are constructed on the housing that maintain rotatability of the rotatable contact bridge.

In addition, switch 1 has a tripping shaft 2 as the tripping unit, which is interactively connected to the movable contact in order to separate the movable contact from the fixed contact 20 during a tripping operation. The circuit breaker has a shutoff device (not shown) that is interactively connected to the contact bridge. The shutoff device can be a switch lock mechanism, pawl mechanism, or the like. The shutoff device is interactively connected to the tripping shaft 2. If the tripping shaft 2 is actuated (rotated) in the tripping direction, the shutoff device rotates the contact bridge about the bearing points on the housing and separates the fixed contacts 20 and the movable contacts (not shown) from one another. The circuit through the circuit breaker is thus interrupted.

The shutoff device also has a mechanism by which the contacts can be reclosed after the circuit breaker has been tripped and the cause of the trip has been eliminated. An electric arc extinction chamber 4 (hereinafter referred to as extinction chamber) is assigned to the fixed contact 20. In FIG. 1, an exhaust duct 6 extends from the extinction chamber 4, essentially parallel to the lower horizontal edge of the housing, to the exterior of the housing. The exhaust duct 6 partially adjoins the walls of the housing and is mounted on the side of the housing that faces away from an operator side of the circuit breaker. The exhaust duct preferably opens to a front face of the housing, thus enabling a plurality of housings to be adjacently attached without mutually obstructing the exhaust ducts. The operation of the exhaust duct and the extinction chamber will be described hereinafter.

Into the exhaust duct 6 projects a first lever arm 8 of a lever 10 at whose end, disposed in the exhaust duct 6, is arranged a barrier surface 14 that obstructs, at least partially, the cross section or the crossarea of the exhaust duct 6. The lever 10 is rotatably or swivelably supported in a pivot 80 on the housing. A second lever arm 18 of the lever 10 is designed as a single unit with the first lever arm 8, and on the end thereof facing away from the pivot 80 is constructed a driver 12. The driver 12 is disposed opposite a catch 16 and is designed to come into contact with the catch 16, disposed on the tripping shaft 2, and to carry same along with the driver during a tripping motion. By designing the driver 12 to act upon a catch 16 in the tripping direction of the tripping shaft 2, tripping shaft 2 can move in the tripping direction independent of the driver 12. As a result, it is possible to actuate the tripping shaft 2 by means of another tripping unit without being influenced by the lever 10 (driver 1 2).

As can be seen further from FIG. 1, the lever arm 18 of the lever 10 has a double construction; that is, the lever arm 18 has an essentially Udesign (in FIG. 1, an inverted “U”). The ends of the legs of the “U” are rotatably held at the mutually aligned pivots 80, while the base of the “U”forms the roddriver 12. In FIG. 1, the legs of the lever arm 18 are also curved into a C shape, such that the point of contact of the driver 12 with the catch 16 opposite from the pivots 80 of the lever arm 18 in FIG. 1 is shifted to the right. FIG. 1 shows the rest position of the lever 10, wherein the Ccurvature of the lever arm 18 aligns the rest position of the lever 10 such that the barrier surface 14 significantly constricts and practically closes the exhaust duct 6. It should be noted that the barrier surface 14 is arranged essentially obliquely to the direction of flow in the exhaust duct. The barrier surface 14 may also be arranged outside the exhaust duct 6, in the vicinity of the opening of same to the ambient surroundings. It is sufficient if the barrier surface 14 is capable of being impacted by a pressure surge in the exhaust duct 6.

In the preferred embodiment, the rest position of the lever 10 according to FIG. 1 is suitably adjusted by the shape of the lever and the equilibrium ratios of the weights on the lever 10. However, the rest position can also be ensured by a spring element (not shown). The spring element may be a coil spring acting as a torsion spring or pressure spring, a flexible tongue on the housing or lever, or only a simple injected tongue if the housing or the lever is injection molded. In addition, the lever 10 can be designed to contact the catch 16 with a slight force in the rest position as well as in the tripped position.

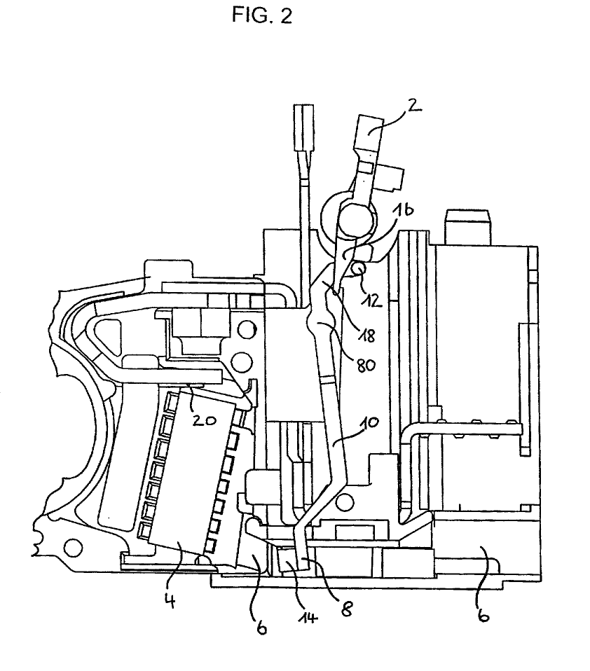

The operation of the circuit breaker 1 will now be discussed in more detail, based on the illustration in FIG. 2. FIG. 2 shows the switch represented in FIG. 1 in a side partial view. As in FIG. 1, the movable contact or contact bridge is also omitted in FIG. 2 in order to provide only a broad overview.

In the event of release, the movable contact (not shown) moves by means of electrodynamic repulsion from the fixed contact 20 in FIG. 2 downwards. The electrodynamic repulsion occurs as a result of magnetic fields around the contact carrier 22 (lower horizontal section) and the contact bridge (not shown) disposed parallel to the contact carrier 22, when the fixed contact 20 and the movable contact (not shown) are closed on the contact bridge. If a high current flows through the circuit breaker, current flows through two parallel conductors (contact holder and contact bridge) in the direction opposing the current. Around the conductors are generated magnetic fields in the same direction which repel one another. If the current becomes high, the magnetic fields become so strong that the magnetics push apart the contacts in opposition to the closing pressure of the contacts. The closing pressure is created by a spring mechanism. The electric arc spread between the movable contact (not shown) and the fixed contact 20 upon separation creates a very rapid pressure rise (approximately 0.5 ms) in the air present in the extinction chamber 4. The pressure rise creates a pressure wave that is propagated through the exhaust duct 6. The exhaust duct 6 connects with the ambient surroundings in order to convey the pressure in the form of the pressure wave.

In its movement through the exhaust duct 6, the very rapid pressure wave impinges upon the barrier surface 14, which constricts the cross section of the exhaust duct 6. The barrier surface 14 yields due to the barrier pressure created, that is, as a result of the difference in pressures on the front side and back side of the barrier surface, toward the end of the exhaust duct 6 on the ambient surroundings side (to the right in FIG. 2). As a result of this yielding motion of the barrier surface 14, the lever 10 upon whose first lever arm 8 the barrier surface 14 is arranged swivels to the right in FIG. 2.

Note should be made that in the preferred embodiment, the barrier surface 14 is exposed to the pressure wave; that is, it is not necessary to have a seal between the barrier surface 14 and the exhaust duct 6. The barrier surface 14 is deflected essentially by the conversion of kinetic energy of the pressure wave into barrier pressure on the barrier surface 14. In other words, the lever is dynamically deflected by the barrier surface. Arrangement of the barrier surface 14 in the exhaust duct 6 can further increase the effect of the barrier surface 14 because the pressure wave is better conducted to the barrier surface.

In FIG. 2, the lever 1 0 rotates in a counterclockwise direction about its pivot 80 on the housing. The second lever arm 18 on the other side of the pivot 80 thereby swivels to the left in FIG. 2. The driver 12 disposed at the end of the second lever arm 18 presses against the pegcatch 16 of the tripping shaft 2 and rotates same in the tripping direction. The circuit breaker is hereby tripped; that is, the movable contact (not shown) and the fixed contact 20 are further displaced from one another and electrically separated via rotation of the contact bridge, by the shutoff device such as a switch lock mechanism, pawl mechanism, or the like. In other words, the electric arc between the contacts is extinguished in the extinction chamber 4.

As can be seen clearly from FIG. 2, the ratio of the lengths of the first lever arm 8 and the second lever arm 18 are chosen so that a deflection of the first lever arm 8 with little force causes a deflection of the second lever arm 18 with great force. More succinctly, the first lever arm 8 is significantly longer than the second lever arm 18. A force can thus be applied by the driver 12 upon the tripping shaft 2 that is reliably sufficient to tripping the circuit breaker. The lever paths of the first and second lever arms are inversely proportional to the lever forces. The pressure wave propagates with almost constant force through the exhaust duct 6, so that the barrier surface 14 remains constantly impacted by the differential pressure over the resulting longer lever path of the first lever arm 8, and thus can easily produce the greater force on the second lever arm 18.

It should be noted that a lever 10 having a barrier surface 14 can be assigned to each exhaust duct of the circuit. In particular, for multipolar circuit breakers this can be achieved with individual levers, each with one barrier surface in each exhaust duct for each pole. Alternatively, to this end, an individual lever can be connected to a plurality of barrier surfaces, each of which is assigned to one exhaust duct. Individual barrier surfaces can be connected to one another by suitable slot openings in the lateral surfaces of the exhaust ducts, for example. A simple solution also consists in arranging one lever having a plurality of barrier surfaces at the respective ambient openings of the exhaust ducts, that is, with only one barrier surface at the end of each exhaust duct. The design of the lever, the connection of the barrier surfaces, and the design of the exhaust ducts can thus be simplified. Optionally, the barrier surfaces can be designed as flaps that close the exhaust ducts and that can prevent the penetration of foreign materials.

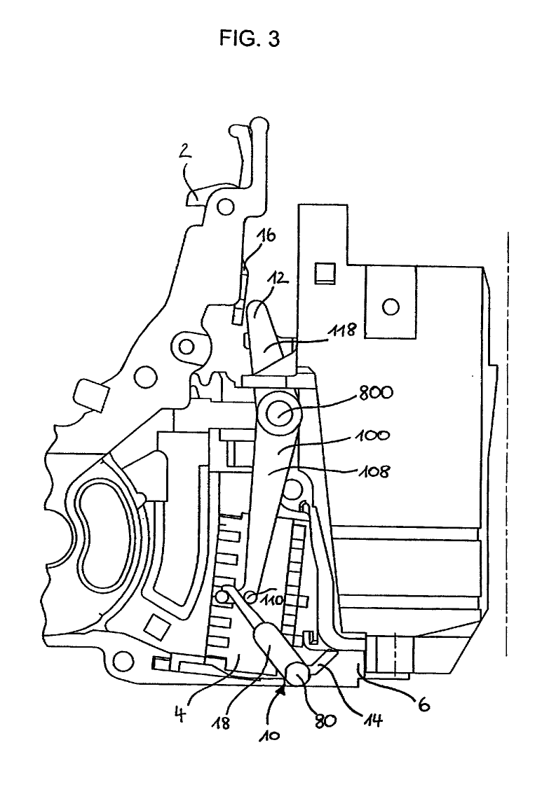

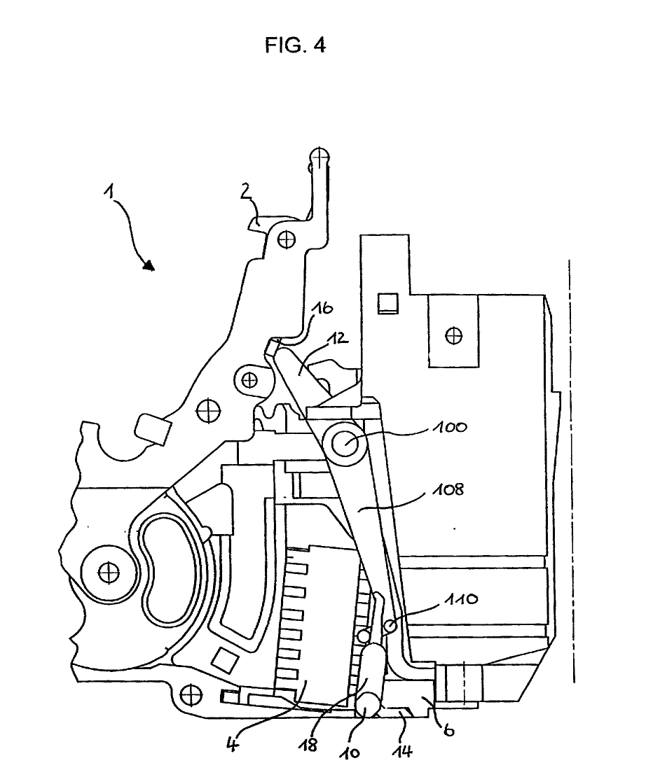

A further embodiment example of the invention is now described with reference to FIGS. 3 and 4. Functionally equivalent elements such as in FIGS. 1 and 2 are denoted by the same reference terms, so that the elements need not be redefined.

The present embodiment example differs from the preceding embodiment example particularly in the arrangement of the barrier surface and of the lever for transmission of forces to the tripping shaft as the tripping unit, so that the key emphasis here is on a description of the deviations from the first embodiment example.

FIG. 3 shows a side view of a section of a circuit breaker in the untripped state, while FIG. 4 shows the same view in the tripped state of the circuit breaker.

FIG. 3 shows an extinction chamber associated with a contact pair (not shown). The extinction chamber is connected via an exhaust duct 6 to the ambient surroundings. In the exhaust duct 6 is disposed a barrier surface 14 that is connected to rotatable shaft 80. A lever extension 18 arranged on the shaft 80 forms a second lever arm 18 of a lever 10, whose first lever arm is formed from the barrier surface 14.

The second lever arm 18 engages with a first trailing lever arm 108 of a trailing lever 100 by means of a hinge 110. The trailing lever 100 is rotatably attached to the housing in a pivot 800. The hinge 110 is designed such that clockwise rotation of the lever 10 about the shaft 80 causes rotational movement of the trailing lever 100 in the counterclockwise direction about the pivot 800. The same correspondingly applies if the rotational directions are reversed.

On a second trailing lever arm 118 of the trailing lever 100 is constructed a driver 12 that can work in combination with an associated catch 16 of the tripping shaft 2 in order to trip the circuit breaker. The engagement between the driver 12 and the catch 16 is analogous to the first embodiment example, so its description will not repeated here.

When an electric arc between the contacts creates a pressure wave in the exhaust duct 6 (see embodiments corresponding to FIG. 2), the barrier surface 14 in FIG. 3 is pressed to the right. The barrier surface 14 hereby rotates the shaft 80, and the second lever arm 18 of the lever 10 attached thereto likewise rotates to the right (in the clockwise direction). Engagement of the second lever arm 18 with the first trailing lever arm 108 via the hinge 110 causes the trailing lever 100 to rotate about the pivot 800 in the counterclockwise direction. The second trailing lever arm 118 swivels to the left and the driver 12 rotates the tripping shaft 2, via the catch 16, in the tripping direction and trips the shutoff device. The stop positions of the levers in the tripped state are shown in FIG. 4.

The hinge 110 and/or the engagement between the driver 12 and the catch 16 can be designed such that both levers 10 and 100 remain in the tripped position if the circuit breaker has been tripped by the pressure wave. Hence, it is simple to make such a tripping event visible by appropriate identification (color marking, window, or the like) on the housing. Furthermore, the hinge can be constructed not only by a lever end received between two pins, but also by a film hinge formed during injection molding of the lever 10 and the trailing lever 100.

Here as well, the lever ratios are chosen to create a sufficient tripping force on the driver 12 of the trailing lever 100.

The alternate embodiment shown in FIG. 3 and FIG. 4 is particularly suited for multipolar circuit breakers that have a plurality of exhaust ducts corresponding to the number of poles. A plurality of barrier surfaces can be connected together in or on individual exhaust ducts via the rotary shaft 80, while the rotary shaft is led through holes in the side walls of each of the exhaust ducts. A simple support of the rotary shaft and a relatively good seal of the individual exhaust ducts against one another is thus achieved, thereby enabling an effective pressure wave to be maintained in each of the exhaust ducts.

Connection of all barrier surfaces to only one trailing lever capable of triggering a common shutoff of all poles of the circuit breaker allows a simple design by which the circuit breaker can be tripped very quickly when a short circuit occurs at only one pole.

It should be noted that in this embodiment as well, the barrier surfaces can be disposed at the ends of the exhaust ducts and/or outside same, as has previously been described with reference to FIG. 1.

Although the present invention has been described with reference to certain embodiments, it will be appreciated that these embodiments are not limitations and that the scope of the invention is defined by the following claims.

What is claimed is:

1. A tripping device for a circuit breaker comprising:
a housing;
at least one contact arranged in a housing, said contacts being separable by actuation of a tripping unit of a shutoff device;
an exhaust duct connected to said housing;
a lever coupled to said tripping unit; and,
a barrier surface connected to said lever and associated with said exhaust duct.

2. The tripping device of claim 1 wherein said lever is rotatably arranged on said housing.

3. The tripping device of claim 1 wherein said lever includes a plurality of barrier surfaces, each of which is assigned to said exhaust duct.

4. The tripping device of claim 1 wherein said lever is interactively connected to the tripping shaft by means of a driver mechanism which permits a tripping motion of said tripping unit independent of said lever.

5. The tripping device of claim 4 wherein said driver mechanism has a catch acted upon in the tripping direction of said tripping unit.

6. The tripping device of claim 5 wherein said lever arm of said lever on said barrier surface side is significantly longer than said lever arm on said tripping unit side.

7. The tripping device of claim 5 wherein said lever engages a trailing lever rotatably supported in the vicinity of said tripping unit.

8. The tripping device of claim 7 wherein said lever and said trailing lever are connected via a hinge that holds said lever and said trailing lever in a respective stop position.

9. The tripping device of claim 7 said lever (10) is connected to a spring element that bias said lever to a rest position.

10. The tripping device of claim 7 wherein said barrier surface forms said one lever arm of the lever.

11. The tripping device of claim 10 further comprising a plurality of barrier surfaces in a plurality of exhaust ducts, said plurality of barrier surfaces being attached on a common rotatably supported shaft.

12. The tripping device of claim 11 wherein said support shaft forms a pivot of the lever.

13. The tripping device of claim 11 wherein said barrier surface is arranged opposite an outlet opening of the assigned exhaust duct.

14. The tripping device of claim 13 wherein said exhaust duct is adjacent an electric arc extinction chamber.

15. The tripping device of claim 14 wherein said pressure wave is created by an electric arc drawn between the separable contacts during electrodynamic shunting.
